(19) United States
(12) Patent Application Publication
(10) Pub. No.: US 2025/0065870 A1
(43) Pub. Date: Feb. 27, 2025

(54) DECELERATION ASSISTANCE APPARATUS, DECELERATION ASSISTANCE METHOD, AND STORAGE MEDIUM

(71) Applicant: TOYOTA JIDOSHA KABUSHIKI KAISHA, Toyota-shi (JP)

(72) Inventors: Toshinori OKITA, Gotemba-shi (JP); Yuki KAWASAKI, Mishima-shi (JP)

(73) Assignee: TOYOTA JIDOSHA KABUSHIKI KAISHA, Toyota-shi (JP)

(21) Appl. No.: 18/750,865

(22) Filed: Jun. 21, 2024

(30) Foreign Application Priority Data
Aug. 25, 2023 (JP) 2023-137450

(51) Int. Cl. B60W 30/14

(52) U.S. Cl. CPC B60W 30/143; B60W 2520/10; B60W 2552/30; B60W 2720/106

(57) ABSTRACT

A deceleration assistance apparatus executes deceleration control that decelerates a vehicle when a vehicle speed of the vehicle is greater than a target vehicle speed set as a target value of a vehicle speed of the vehicle when the vehicle travels on a curved road. The deceleration assistance apparatus is configured to cause the target vehicle speed to be greater by a predetermined value or is configured to not execute the deceleration control even when the vehicle speed of the vehicle is greater than the target vehicle speed when a predetermined condition in which a decrease of a deceleration speed of the vehicle is detected when the vehicle travels on the curved road is met.

### CROSS-REFERENCE TO RELATED APPLICATION

This application claims priority to Japanese Patent Application No. 2023-137450 filed on Aug. 25, 2023 incorporated herein by reference in its entirety.

### BACKGROUND

### 1. Technical Field

The present disclosure relates to a deceleration assistance apparatus, a deceleration assistance method, and a storage medium.

### 2. Description of Related Art

A driving assistance apparatus that achieves smooth traveling of a vehicle on a curved road by autonomously controlling the acceleration and deceleration speed of the vehicle when the vehicle is traveling on the curved road has been known (for example, see Japanese Unexamined Patent Application Publication No. 2008-189199).

### SUMMARY

When an operator of a vehicle is in a state of releasing a brake pedal and the deceleration speed of the vehicle at the time point is remaining when the vehicle is traveling on a curved road, there is a high possibility that the deceleration of the vehicle by deceleration control is not needed because the operator of the vehicle is judging that the vehicle speed of the vehicle has sufficiently decreased. When the deceleration control is executed at this time, there is a risk that the operator of the vehicle may feel uncomfortable.

An object of the present disclosure is to provide a deceleration assistance apparatus, a deceleration assistance method, and a storage medium capable of reducing cases in which an operator of a vehicle feels uncomfortable due to deceleration control being executed when a vehicle is traveling on a curved road.

A deceleration assistance apparatus according to the present disclosure includes a control apparatus that executes deceleration control that decelerates a vehicle when a vehicle speed of the vehicle is greater than a target vehicle speed set as a target value of the vehicle speed of the vehicle when the vehicle travels on a curved road. The control apparatus is configured to cause the target vehicle speed to be greater by a predetermined value or is configured to not execute the deceleration control even when the vehicle speed of the vehicle is greater than the target vehicle speed when a predetermined condition in which a decrease of a deceleration speed of the vehicle is detected when the vehicle travels on the curved road is met.

As described above, when the operator of a vehicle is in a state of releasing the brake pedal and the deceleration speed of the vehicle at the time point is remaining when the vehicle is traveling on the curved road, there is a high possibility that the deceleration of the vehicle by the deceleration control is not needed because the operator of the vehicle is judging that the vehicle speed of the vehicle has sufficiently decreased. When the deceleration control is executed at this time, there is a risk that the operator of the vehicle may feel uncomfortable.

According to the deceleration assistance apparatus according to the present disclosure, when there is a high possibility that the deceleration of the vehicle by the deceleration control is not needed because the predetermined condition in which the decrease of the deceleration speed of the vehicle is detected is met and the operator of the vehicle is judging that the vehicle speed of the vehicle has sufficiently decreased when the vehicle is traveling on the curved road, the target vehicle speed is caused to be greater by a predetermined value or the deceleration control is not executed even when the vehicle speed of the vehicle is greater than the target vehicle speed. Therefore, it becomes possible to reduce cases in which the operator of the vehicle feels uncomfortable due to the deceleration control being executed when the vehicle is traveling on the curved road.

In the deceleration assistance apparatus according to the present disclosure, the predetermined condition may include a condition in which the deceleration speed at a time point at which the decrease of the deceleration speed of the vehicle is detected is equal to or more than a predetermined deceleration speed.

According to the above, the target vehicle speed is caused to be greater when the deceleration speed of the vehicle is great and there is a high possibility that a sufficient load is applied to front wheels of the vehicle as a result thereof. Therefore, it becomes possible to more suitably reduce cases in which the operator of the vehicle feels uncomfortable due to the deceleration control being executed when the vehicle is traveling on the curved road.

In the deceleration assistance apparatus according to the present disclosure, the predetermined condition may include a condition in which the decrease of the deceleration speed of the vehicle is detected at a time point at which the vehicle enters the curved road.

According to the above, the target vehicle speed is caused to be greater when the deceleration speed of the vehicle has started to decrease or has decreased at the time point at which the vehicle enters the curved road and hence there is a high possibility that the vehicle speed of the vehicle has sufficiently decreased for the operator of the vehicle at the time point at which the vehicle enters the curved road. Therefore, it becomes possible to more suitably reduce cases in which the operator of the vehicle feels uncomfortable due to the deceleration control being executed when the vehicle is traveling on the curved road.

A deceleration assistance method according to the present disclosure is a method that executes deceleration control that decelerates a vehicle when a vehicle speed of the vehicle is greater than a target vehicle speed set as a target value of the vehicle speed of the vehicle when the vehicle travels on a curved road. The deceleration assistance method according to the present disclosure includes a step of causing the target vehicle speed to be greater by a predetermined value or not executing the deceleration control even when the vehicle speed of the vehicle is greater than the target vehicle speed when a predetermined condition in which a decrease of a deceleration speed of the vehicle is detected when the vehicle travels on the curved road is met.

According to the above, it becomes possible to reduce cases in which the operator of the vehicle feels uncomfortable due to the deceleration control being executed when the vehicle is traveling on the curved road from a reason similar to that described above.

A storage medium according to the present disclosure is a storage medium storing instructions that are executable by one or more processors and that cause the one or more processors to perform functions including: executing deceleration control that decelerates a vehicle when a vehicle speed of the vehicle is greater than a target vehicle speed set as a target value of the vehicle speed of the vehicle when the vehicle travels on a curved road; and causing the target vehicle speed to be greater by a predetermined value or not executing the deceleration control even when the vehicle speed of the vehicle is greater than the target vehicle speed when a predetermined condition in which a decrease of a deceleration speed of the vehicle is detected when the vehicle travels on the curved road is met.

According to the above, it becomes possible to reduce cases in which the operator of the vehicle feels uncomfortable due to the deceleration control being executed when the vehicle is traveling on the curved road from a reason similar to that described above.

Components of the present disclosure are not limited to the embodiment of the present disclosure described below with reference to the drawings. Other objects, other features, and associated advantages of the present disclosure shall be easily understood from the description of the embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a deceleration assistance apparatus according to an embodiment of the present disclosure;

FIG. 2A is a view showing a scene in which a vehicle on which the deceleration assistance apparatus according to the embodiment of the present disclosure is mounted has entered a curved road;

FIG. 2B is a view showing a scene in which the vehicle on which the deceleration assistance apparatus according to the embodiment of the present disclosure is mounted is traveling on the curved road;

FIG. 3 is a flowchart showing a routine executed by the deceleration assistance apparatus according to the embodiment of the present disclosure;

FIG. 4 is a flowchart showing a routine executed by the deceleration assistance apparatus according to the embodiment of the present disclosure;

FIG. 5 is a diagram showing a region that is defined by a lateral acceleration speed and a deceleration speed of an own vehicle and that meets a target vehicle speed changing condition or an execution prohibition condition;

FIG. 6A is a diagram similar to FIG. 5 and showing one example of a change of the lateral acceleration speed and the deceleration speed of the own vehicle when the own vehicle turns right on the curved road;

FIG. 6B is a diagram similar to FIG. 5 and showing one example of a change of the lateral acceleration speed and the deceleration speed of the own vehicle when the own vehicle turns right on the curved road;

FIG. 6C is a diagram showing a transition of the target vehicle speed and the like when the lateral acceleration speed and the deceleration speed of the own vehicle change as shown in FIG. 6A and FIG. 6B;

FIG. 7A is a diagram similar to FIG. 5 and showing another example of a change of the lateral acceleration speed and the deceleration speed of the own vehicle when the own vehicle turns right on the curved road;

FIG. 7B is a diagram similar to FIG. 5 and showing another example of a change of the lateral acceleration speed and the deceleration speed of the own vehicle when the own vehicle turns right on the curved road;

FIG. 7C is a diagram showing a transition of the target vehicle speed and the like when the lateral acceleration speed and the deceleration speed of the own vehicle change as shown in FIG. 7A and FIG. 7B; and

FIG. 8 is a diagram showing one example of a transition of the target vehicle speed and the like when the lateral acceleration speed and the deceleration speed of the own vehicle change.

### DETAILED DESCRIPTION OF EMBODIMENTS

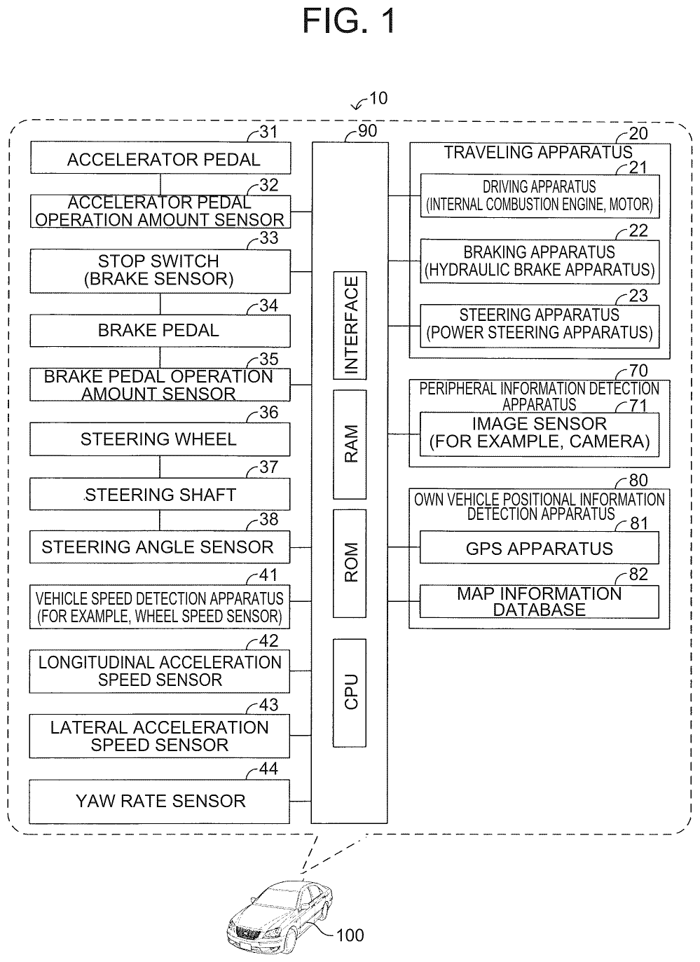

A deceleration assistance apparatus, a deceleration assistance method, and a storage medium according to an embodiment of the present disclosure are described below with reference to the drawings. FIG. 1 shows a deceleration assistance apparatus 10. The deceleration assistance apparatus 10 is mounted on an own vehicle 100. The deceleration assistance apparatus 10 is described below with use of an example in which an operator of the own vehicle 100 is a person that rides the own vehicle 100 and drives the own vehicle 100 (in other words, a driver of the own vehicle 100).

However, the operator of the own vehicle 100 may be a person that does not ride the own vehicle 100 and remotely drives the own vehicle 100 (in other words, a remote operator of the own vehicle 100). When the operator of the own vehicle 100 is a remote operator, the deceleration assistance apparatus 10 is mounted on each of the own vehicle 100 and a remote operation equipment installed outside the own vehicle 100 in order to remotely drive the own vehicle 100, and functions of the deceleration assistance apparatus 10 described below are performed by being shared between the deceleration assistance apparatus 10 mounted on the own vehicle 100 and the deceleration assistance apparatus 10 mounted on the remote operation equipment.

As shown in FIG. 1, the deceleration assistance apparatus 10 includes an electronic control apparatus (ECU) 90 serving as a control apparatus. The ECU 90 includes a microcomputer as a main part. The microcomputer includes a CPU, a storage medium such as a ROM, a RAM, and a non-volatile memory, an interface, and the like. The CPU realizes various functions by executing an instruction, a program, or a routine stored in the storage medium. In particular, in the present example, the deceleration assistance apparatus 10 stores a program that realizes various controls executed by the deceleration assistance apparatus 10 in the storage medium.

In the present example, the deceleration assistance apparatus 10 includes only one ECU 90. However, the deceleration assistance apparatus 10 may include a plurality of ECUs, and the functions of the deceleration assistance apparatus 10 described below may be performed by being shared between each of the ECUs.

The deceleration assistance apparatus 10 may be configured to be able to update the program stored in the storage medium by wireless communication (for example, Internet communication) with an external apparatus.

### Traveling Apparatus

A traveling apparatus 20 is mounted on the own vehicle 100. The traveling apparatus 20 includes a driving apparatus 21, a braking apparatus 22, and a steering apparatus 23.

The driving apparatus 21 is an apparatus that outputs a driving force (driving torque) applied to the own vehicle 100 in order to cause the own vehicle 100 to travel and is an internal combustion engine and a motor, for example. The driving apparatus 21 is electrically connected to the ECU 90. The deceleration assistance apparatus 10 can control a driving force output from the driving apparatus 21 by controlling the operation of the driving apparatus 21.

The braking apparatus 22 is an apparatus that outputs a braking force (braking torque) applied to the own vehicle 100 in order to brake the own vehicle 100 and is a hydraulic brake apparatus, for example. The braking apparatus 22 is electrically connected to the ECU 90. The deceleration assistance apparatus 10 can control a braking force output from the braking apparatus 22 by controlling the operation of the braking apparatus 22.

The steering apparatus 23 is an apparatus that outputs a steering force (steering torque) applied to the own vehicle 100 in order to steer the own vehicle 100 and is a power steering apparatus, for example. The steering apparatus 23 is electrically connected to the ECU 90. The deceleration assistance apparatus 10 can control a steering force output from the steering apparatus 23 by controlling the operation of the steering apparatus 23.

### Sensor and the Like

In the own vehicle 100, an accelerator pedal 31, an accelerator pedal operation amount sensor 32, a stop switch 33, a brake pedal 34, a brake pedal operation amount sensor 35, a steering wheel 36, a steering shaft 37, a steering angle sensor 38, a vehicle speed detection apparatus 41, a longitudinal acceleration speed sensor 42, a lateral acceleration speed sensor 43, a yaw rate sensor 44, a peripheral information detection apparatus 70, and an own vehicle positional information detection apparatus 80 are mounted.

The accelerator pedal operation amount sensor 32 is a sensor that detects the operation amount of the accelerator pedal 31 and is electrically connected to the ECU 90. The deceleration assistance apparatus 10 acquires the operation amount of the accelerator pedal 31 by the accelerator pedal operation amount sensor 32 as an accelerator pedal operation amount AP. The deceleration assistance apparatus 10 acquires a requested driving force (requested driving torque) on the basis of the accelerator pedal operation amount AP and the traveling speed of the own vehicle 100 and controls the operation of the driving apparatus 21 such that a driving force equivalent to the requested driving force is applied to the own vehicle 100 from the driving apparatus 21.

The stop switch 33 is a sensor (brake sensor) that detects an operation by the driver of the own vehicle 100 with respect to the brake pedal 34 and is electrically connected to the ECU 90. The deceleration assistance apparatus 10 detects the operation by the driver of the own vehicle 100 with respect to the brake pedal 34 by the stop switch 33.

The brake pedal operation amount sensor 35 is a sensor that detects the operation amount of the brake pedal 34 and is electrically connected to the ECU 90. The deceleration assistance apparatus 10 acquires the operation amount of the brake pedal 34 by the brake pedal operation amount sensor 35 as a brake pedal operation amount BP. The deceleration assistance apparatus 10 acquires a requested braking force (requested braking torque) on the basis of the brake pedal operation amount BP and controls the operation of the braking apparatus 22 such that a braking force equivalent to the requested braking force is applied to the own vehicle 100 from the braking apparatus 22.

The steering angle sensor 38 is a sensor that detects the rotational angle of the steering shaft 37 with respect to a neutral position and is electrically connected to the ECU 90. The deceleration assistance apparatus 10 acquires the rotational angle of the steering shaft 37 by the steering angle sensor 38 as a steering angle θ.

The deceleration assistance apparatus 10 acquires a requested steering force (requested steering torque) on the basis of the steering angle θ and the traveling speed of the own vehicle 100 and controls the operation of the steering apparatus 23 such that a steering force equivalent to the requested steering force is applied to the own vehicle 100 from the steering apparatus 23.

The vehicle speed detection apparatus 41 is an apparatus that detects the traveling speed of the own vehicle 100 and is a wheel speed sensor, for example. The vehicle speed detection apparatus 41 is electrically connected to the ECU 90. The deceleration assistance apparatus 10 acquires the traveling speed of the own vehicle 100 by the vehicle speed detection apparatus 41 as an own vehicle speed V.

The longitudinal acceleration speed sensor 42 is a sensor that detects the acceleration speed of the own vehicle 100 in the front-rear direction (longitudinal direction). The longitudinal acceleration speed sensor 42 is electrically connected to the ECU 90. The deceleration assistance apparatus 10 acquires the acceleration speed of the own vehicle 100 in the front-rear direction by the longitudinal acceleration speed sensor 42 as a longitudinal acceleration speed Gx.

The lateral acceleration speed sensor 43 is a sensor that detects the acceleration speed of the own vehicle 100 in the width direction (lateral direction). The lateral acceleration speed sensor 43 is electrically connected to the ECU 90. The deceleration assistance apparatus 10 acquires the acceleration speed of the own vehicle 100 in the width direction by the lateral acceleration speed sensor 43 as a lateral acceleration speed Gy.

The yaw rate sensor 44 is a sensor that detects the yaw rate of the own vehicle 100. The yaw rate sensor 44 is electrically connected to the ECU 90. The deceleration assistance apparatus 10 acquires the yaw rate of the own vehicle 100 by the yaw rate sensor 44 as a yaw rate YR.

The peripheral information detection apparatus 70 is an apparatus that detects information on the periphery of the own vehicle 100 and includes an image sensor 72 in the present example.

The image sensor 72 is a camera, for example, and is electrically connected to the ECU 90. The deceleration assistance apparatus 10 acquires image information relating to the periphery of the own vehicle 100 by the image sensor 72 as peripheral detection information IS.

The own vehicle positional information detection apparatus 80 includes a GPS apparatus 81 and a map information database 82.

The GPS apparatus 81 is an apparatus that receives a so-called GPS signal and is electrically connected to the ECU 90. The deceleration assistance apparatus 10 can acquire a GPS signal via the GPS apparatus 81 and specify (acquire) the position of the own vehicle 100 on the basis of the acquired GPS signal.

The map information database 82 is a database storing the map information IM therein and is electrically connected to the ECU 90. The deceleration assistance apparatus 10 can specify the place in which the own vehicle 100 is positioned on a map indicated by the map information IM on the basis of the map information IM and the position of the own vehicle 100 specified from a GPS signal.

### Operation of Deceleration Assistance Apparatus

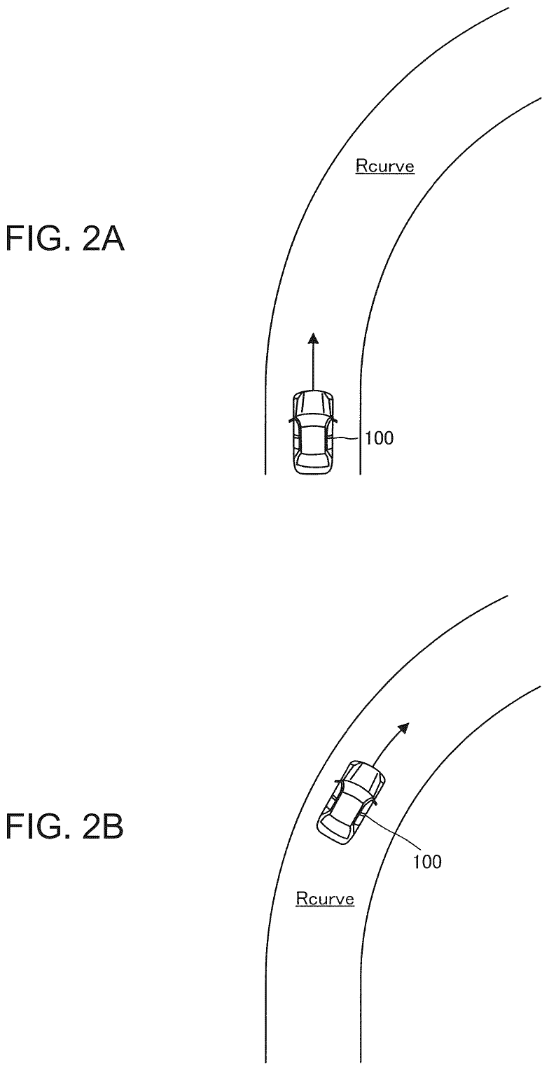

Next, the operation of the deceleration assistance apparatus 10 is described. As shown in FIG. 2A and FIG. 2B, when the own vehicle speed V is greater than a target vehicle speed Vtgt when the own vehicle 100 is traveling on a curved road Rcurve, the deceleration assistance apparatus 10 executes deceleration control that controls the operation of the braking apparatus 22 and decelerates the own vehicle 100. In other words, the deceleration assistance apparatus 10 executes the deceleration control that decelerates the own vehicle 100 when the own vehicle speed V is greater than the target vehicle speed Vtgt set as a target value of the own vehicle speed V when the own vehicle 100 is traveling on the curved road Rcurve.

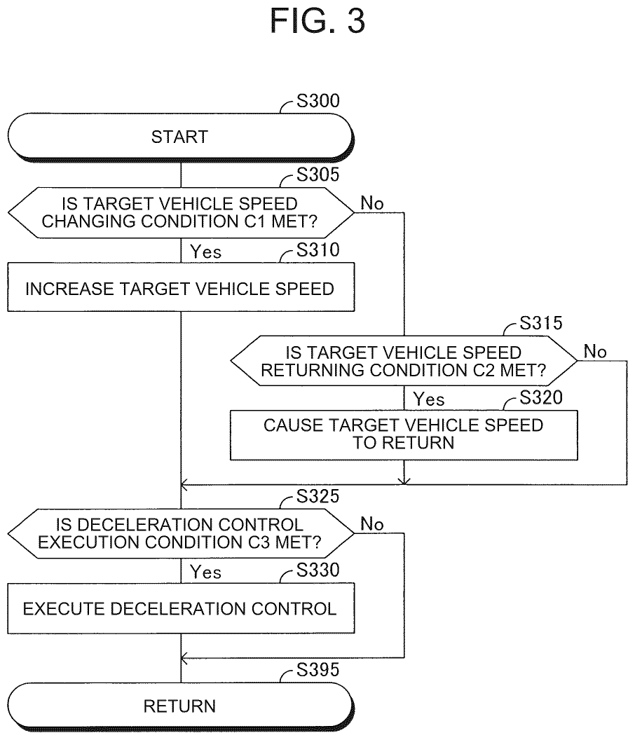

More specifically, the deceleration assistance apparatus 10 executes deceleration control when a certain condition is met by executing a routine shown in FIG. 3 at a predetermined time interval. Therefore, when a predetermined timing is reached, the deceleration assistance apparatus 10 starts processing from Step S300 in the routine shown in FIG. 3, causes the processing to proceed to Step S305, and determines whether a target vehicle speed changing condition C1 (predetermined condition) is met.

The target vehicle speed changing condition C1 is a condition in which the decrease of the deceleration speed Gd of the own vehicle 100 is detected at a time point at which the own vehicle 100 enters the curved road Rcurve and the deceleration speed Gd at the time point is equal to or more than a predetermined deceleration speed Gd_th.

Whether the own vehicle 100 has entered the curved road Rcurve is determined on the basis of the lateral acceleration speed Gy, and it is determined that the own vehicle 100 has entered the curved road Rcurve when the lateral acceleration speed Gy becomes greater than zero or becomes greater than a predetermined value that is greater than zero but is relatively small. However, whether the own vehicle 100 has entered the curved road Rcurve may be determined on the basis of the steering angle θ or the yaw rate YR. Alternatively, whether the own vehicle 100 has entered the curved road Rcurve may be determined on the basis of the peripheral detection information IS or may be determined on the basis of the map information IM and the position of the own vehicle 100 specified from a GPS signal.

The deceleration speed Gd of the own vehicle 100 is detected by the longitudinal acceleration speed sensor 42. At this time, the acceleration speed detected by the longitudinal acceleration speed sensor 42 is a positive value when the own vehicle 100 is accelerating and is a negative value when the own vehicle 100 is decelerating. Therefore, the deceleration speed Gd of the own vehicle 100 is an absolute value of the longitudinal acceleration speed Gx that is a negative value detected by the longitudinal acceleration speed sensor 42.

Even when the deceleration speed Gd of the own vehicle 100 cannot be acquired, there is a high probability that the deceleration speed Gd has started to decrease or has decreased at a time point at which the own vehicle 100 enters the curved road Rcurve when it is detected that the brake pedal 34 is released by the driver at a time point at which the own vehicle 100 enters the curved road Rcurve or a time point immediately after the time point. Therefore, the target vehicle speed changing condition C1 may be a condition in which the brake pedal 34 is released by the driver at a time point at which the own vehicle 100 enters the curved road Rcurve or a time point immediately after the time point.

In this case, whether the brake pedal 34 is released by the driver is detected by the stop switch 33. In other words, when the operation of the brake pedal 34 cannot be detected by the stop switch 33, it is determined that the brake pedal 34 is released by the driver. However, whether the brake pedal 34 is released by the driver may be determined on the basis of the brake pedal operation amount BP. In this case, it is determined that the brake pedal 34 is released by the driver when the brake pedal operation amount BP becomes zero. Alternatively, whether the brake pedal 34 is released by the driver may be determined on the basis of the brake hydraulic pressure of the hydraulic brake apparatus. In this case, it is determined that the brake pedal 34 is released by the driver when the brake hydraulic pressure becomes zero or equal to or less than a predetermined value.

When the deceleration assistance apparatus 10 determines that Step S305 is “Yes”, the deceleration assistance apparatus 10 causes the processing to proceed to Step S310, and causes the target vehicle speed Vtgt to be greater by a predetermined value ΔV. In other words, the deceleration assistance apparatus 10 sets a vehicle speed that is greater than the current target vehicle speed Vtgt by the predetermined value ΔV as the new target vehicle speed Vtgt. Next, the deceleration assistance apparatus 10 causes the processing to proceed to Step S325.

The predetermined value ΔV may be a certain value or may be a variable value set on the basis of at least one of the own vehicle speed V, the yaw rate YR, the curvature of the curved road Rcurve, and the like.

Meanwhile, when the deceleration assistance apparatus 10 determines Step S305 to be “No”, the deceleration assistance apparatus 10 causes the processing to proceed to Step S315 and determines whether a target vehicle speed returning condition C2 is met. The target vehicle speed returning condition C2 is a condition in which the own vehicle 100 enters the curved road Rcurve and the steering wheel 36 is rotated so as to be spaced apart from a neutral position, and then the steering wheel 36 is rotated toward the neutral position and the steering angle θ becomes equal to or less than a predetermined angle θth.

When the deceleration assistance apparatus 10 determines that Step S315 is “Yes”, the deceleration assistance apparatus 10 causes the processing to proceed to Step S320 and causes the target vehicle speed Vtgt to be smaller by the predetermined value ΔV when the target vehicle speed Vtgt is set to a vehicle speed that is greater by the predetermined value ΔV in Step S310. In other words, when the target vehicle speed Vtgt is set to a vehicle speed greater by the predetermined value ΔV in Step S310, the deceleration assistance apparatus 10 sets a vehicle speed smaller than the current target vehicle speed Vtgt by the predetermined value ΔV as the new target vehicle speed Vtgt. In other words, the deceleration assistance apparatus 10 causes the target vehicle speed Vtgt to return to the original target vehicle speed Vtgt. Next, the deceleration assistance apparatus 10 causes the processing to proceed to Step S325.

Meanwhile, when the deceleration assistance apparatus 10 determines that Step S315 is “No”, the deceleration assistance apparatus 10 causes the processing to directly proceed to Step S325.

Next, when the deceleration assistance apparatus 10 causes the processing to proceed to Step S325, the deceleration assistance apparatus 10 determines whether a deceleration control execution condition C3 is met. The deceleration control execution condition C3 is a condition in which the own vehicle speed V is greater than the target vehicle speed Vtgt.

When the deceleration assistance apparatus 10 determines that Step S325 is “Yes”, the deceleration assistance apparatus 10 causes the processing to proceed to Step S330 and executes the deceleration control. The deceleration control is ended when the own vehicle speed V becomes equal to or less than the target vehicle speed Vtgt.

Next, the deceleration assistance apparatus 10 causes the processing to proceed to Step S395 and temporarily ends the processing of the present routine.

Meanwhile, when the deceleration assistance apparatus 10 determines that Step S325 is “No”, the deceleration assistance apparatus 10 causes the processing to directly proceed to Step S395 and temporarily ends the processing of the present routine.

According to the routine shown in FIG. 3, the target vehicle speed Vtgt becomes greater at a time point at which the target vehicle speed changing condition C1 is met, but the target vehicle speed Vtgt only needs to be caused to be greater until the deceleration speed Gd becomes zero after the target vehicle speed changing condition C1 is met in the present disclosure.

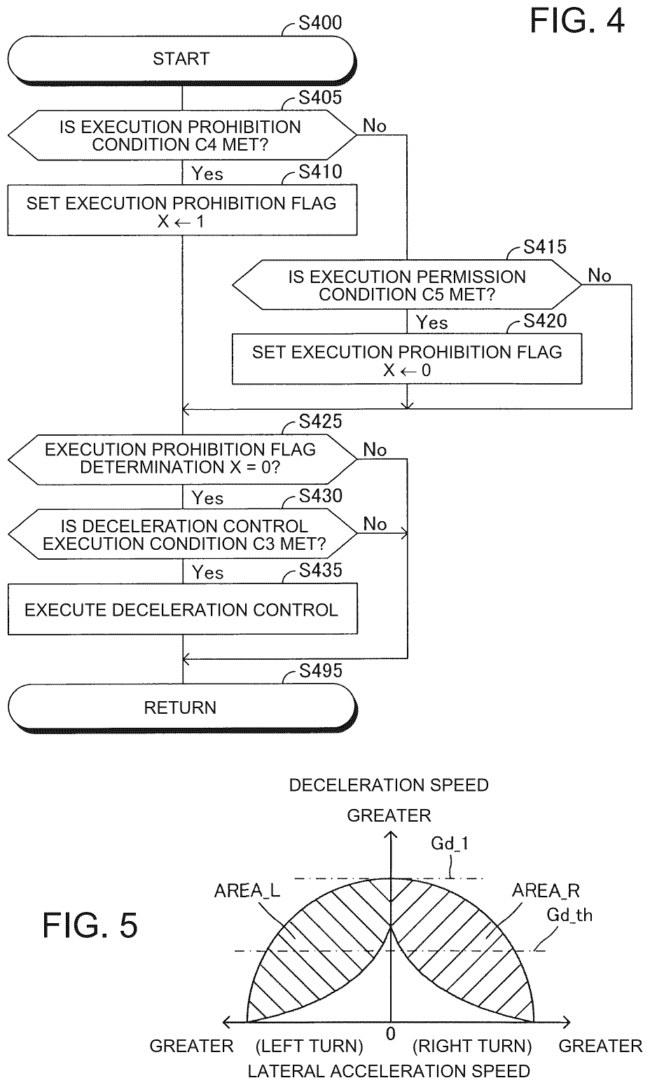

Alternatively, the deceleration assistance apparatus 10 may execute the deceleration control when a certain condition is met by executing a routine shown in FIG. 4 at a predetermined time interval. In this case, when a predetermined timing is reached, the deceleration assistance apparatus 10 starts processing from Step S400 in the routine shown in FIG. 4, causes the processing to proceed to Step S405, and determines whether an execution prohibition condition C4 is met. In the present example, the execution prohibition condition C4 is the same condition as the target vehicle speed changing condition C1.

When the deceleration assistance apparatus 10 determines that Step S405 is “Yes”, the deceleration assistance apparatus 10 causes the processing to proceed to Step S410 and sets the value of an execution prohibition flag X to be “1”. Next, the deceleration assistance apparatus 10 causes the processing to proceed to Step S425. As a result, the execution of the deceleration control is prohibited. Therefore, the deceleration control is not executed even when the own vehicle speed V is greater than the target vehicle speed Vtgt.

Meanwhile, when the deceleration assistance apparatus 10 determines that Step S405 is “No”, the deceleration assistance apparatus 10 causes the processing to proceed to Step S415 and determines whether an execution permission condition C5 is met. In the present example, the execution permission condition C5 is the same condition as the target vehicle speed returning condition C2.

When the deceleration assistance apparatus 10 determines that Step S415 is “Yes”, the deceleration assistance apparatus 10 causes the processing to proceed to Step S420 and sets the value of the execution prohibition flag X to be “0”. Next, the deceleration assistance apparatus 10 causes the processing to proceed to Step S425. As a result, the prohibition of the execution of the deceleration control is removed.

Meanwhile, when the deceleration assistance apparatus 10 determines that Step S415 is “No”, the deceleration assistance apparatus 10 causes the processing to directly proceed to Step S425.

Next, when the deceleration assistance apparatus 10 causes the processing to proceed to Step S425, the deceleration assistance apparatus 10 determines whether the value of the execution prohibition flag X is set to “0”.

When the deceleration assistance apparatus 10 determines that Step S425 is “Yes”, the deceleration assistance apparatus 10 causes the processing to proceed to Step S430 and determines whether the deceleration control execution condition C3 is met.

When the deceleration assistance apparatus 10 determines that Step S430 is “Yes”, the deceleration assistance apparatus 10 causes the processing to proceed to Step S435 and executes the deceleration control. Next, the deceleration assistance apparatus 10 causes the processing to proceed to Step S495 and temporarily ends the processing of the present routine.

Meanwhile, when the deceleration assistance apparatus 10 determines that Step S425 or S430 is “No”, the deceleration assistance apparatus 10 causes the processing to directly proceed to Step S495 and temporarily ends the processing of the present routine.

According to the routine shown in FIG. 4, the execution of the deceleration control is prohibited at the time point at which the execution prohibition condition C4 is met. However, in the present disclosure, the prohibition of the execution of the deceleration control only needs to be performed until the deceleration speed Gd becomes zero after the execution prohibition condition C4 is met.

The operation of the deceleration assistance apparatus 10 has been described above.

When the decrease of the deceleration speed Gd of the own vehicle 100 is detected at a time point at which the own vehicle 100 enters the curved road Rcurve and the deceleration speed Gd at the time point is remaining, the driver is judging that the vehicle speed of the own vehicle 100 has sufficiently decreased and a sufficient load is remaining on front wheels of the own vehicle 100. Therefore, there is a high possibility that the deceleration of the own vehicle 100 by the deceleration control is not needed. When the deceleration control is executed at this time, there is a risk that the driver may feel uncomfortable.

As shown in FIG. 5, for example, according to the deceleration assistance apparatus 10, when the deceleration speed Gd that has risen to a certain value Gd_1 that is greater than the predetermined deceleration speed Gd_th decreases within a region AREA_R or a region AREA_L after the own vehicle 100 enters the curved road Rcurve, the target vehicle speed Vtgt is caused to be greater by the predetermined value ΔV or the execution of the deceleration control is prohibited.

In a graph shown in FIG. 5, the horizontal axis indicates the lateral acceleration speed Gy, and the vertical axis indicates the deceleration speed Gd. In the graph shown in FIG. 5, the positive value on the horizontal axis is the lateral acceleration speed Gy when the own vehicle 100 turns right, and the negative value on the horizontal axis is the lateral acceleration speed Gy when the own vehicle 100 turns left.

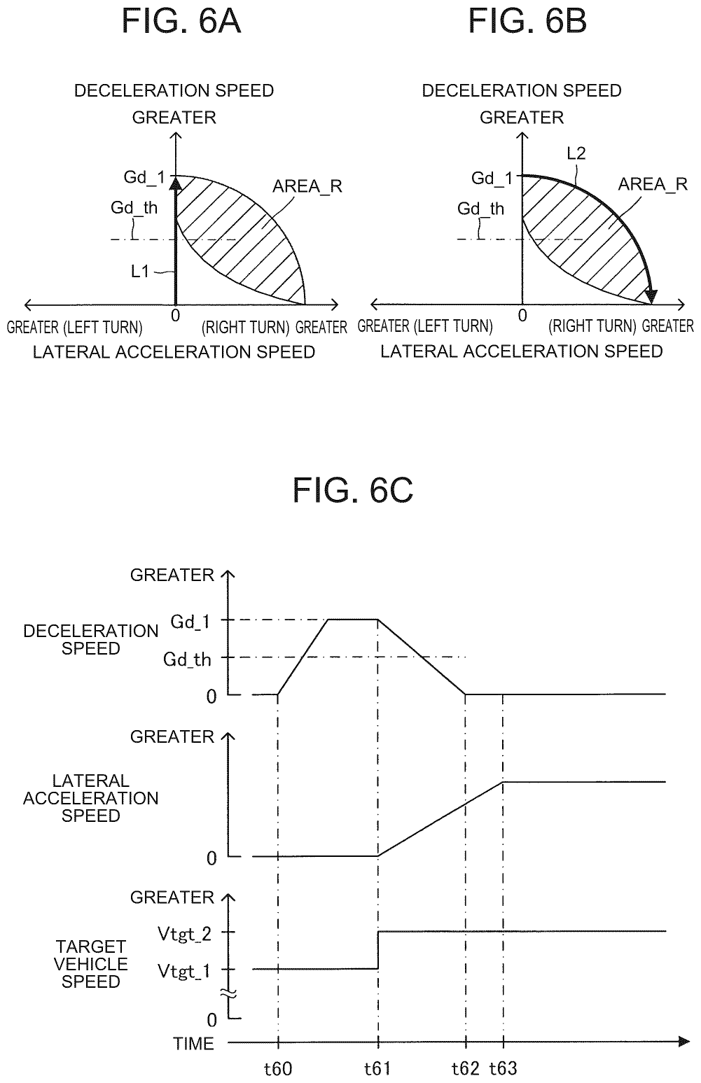

For example, in a case in which the own vehicle 100 enters the curved road Rcurve and turns right, when the deceleration speed Gd rises to the certain value Gd_1 as indicated by a line L1 in FIG. 6A, the deceleration speed Gd thereafter starts to decrease at a time point at which the own vehicle 100 enters the curved road Rcurve, the lateral acceleration speed Gy rises along a line L2 indicated by FIG. 6B, and the deceleration speed Gd decreases, the target vehicle speed Vtgt is caused to be greater by the predetermined value ΔV as shown in FIG. 6C.

In other words, in the example shown in FIG. 6C, the deceleration speed Gd reaches the certain value Gd_1 that is greater than the predetermined deceleration speed Gd_th after the deceleration speed Gd starts to rise at time t60. Then, at time t61, the own vehicle 100 enters the curved road Rcurve, the lateral acceleration speed Gy starts to rise, and the deceleration speed Gd starts to decrease. Then, the deceleration speed Gd becomes zero at time t62. The lateral acceleration speed Gy continues to rise from time t61 to time t63 and becomes constant at time t63 and thereafter.

In this case, a predetermined condition (target vehicle speed changing condition C1) in which the decrease of the deceleration speed Gd is detected at a time point at which the own vehicle 100 enters the curved road Rcurve at time t61 and the deceleration speed Gd at the time point is equal to or more than the predetermined deceleration speed Gd_th is met. Therefore, at the time point, the target vehicle speed Vtgt is changed to a value Vtgt_2 that is greater than the value Vtgt_1 by the predetermined value ΔV.

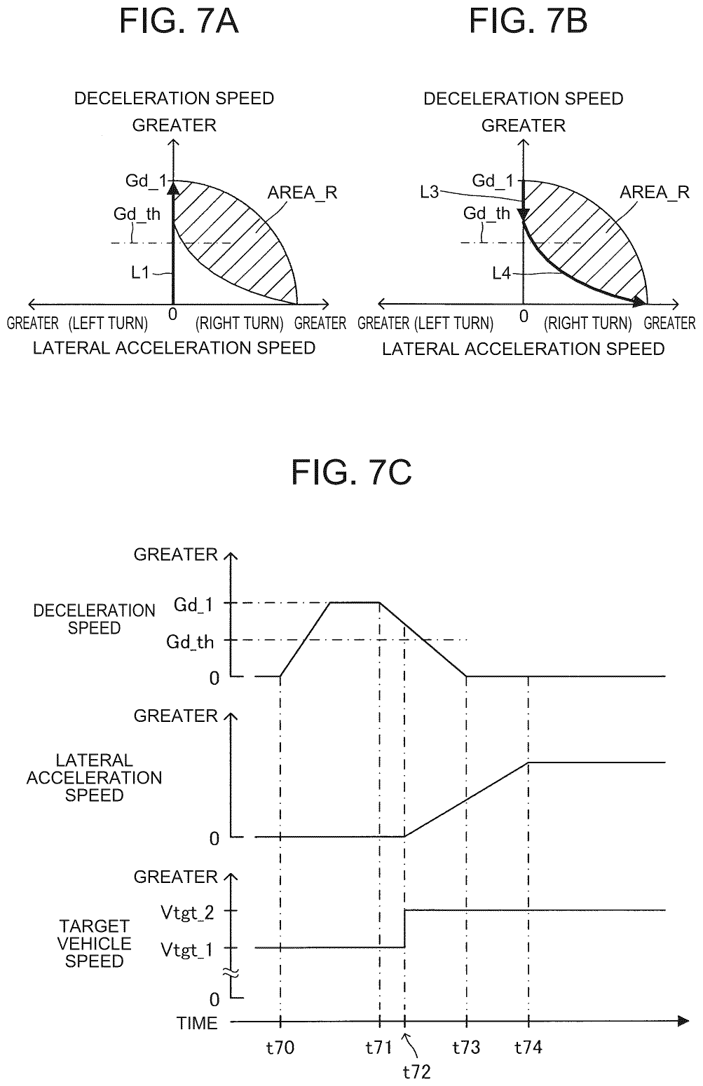

In a case in which the own vehicle 100 enters the curved road Rcurve and turns right, when the deceleration speed Gd rises to the certain value Gd_1 as indicated by a line L1 in FIG. 7A and the deceleration speed Gd decreases thereafter as indicated by a line L3, the following occurs. When the own vehicle 100 enters the curved road Rcurve, the lateral acceleration speed Gy rises along a line L4 indicated in FIG. 7B, and the deceleration speed Gd decreases, the target vehicle speed Vtgt is caused to be greater by the predetermined value ΔV as indicated in FIG. 7C.

In other words, in the example shown in FIG. 7C, after the deceleration speed Gd starts to rise at time t70, the certain value Gd_1 that is greater than the predetermined deceleration speed Gd_th is reached. Then, the deceleration speed Gd starts to decrease at time t71. Then, the own vehicle 100 enters the curved road Rcurve and the lateral acceleration speed Gy starts to rise at time t72 at which the deceleration speed Gd is equal to or more than the predetermined deceleration speed Gd_th. Then, the deceleration speed Gd becomes zero at time t73. The lateral acceleration speed Gy continues to rise from time t72 to time t74 and becomes constant at time t74 and thereafter.

In this case, a predetermined condition (target vehicle speed changing condition C1) in which the decrease of the deceleration speed Gd is detected at a time point at which the own vehicle 100 enters the curved road Rcurve at time t72 and the deceleration speed Gd at the time point is equal to or more than the predetermined deceleration speed Gd_th is met. Therefore, at the time point, the target vehicle speed Vtgt is changed to a value Vtgt_2 that is greater than the value Vtgt_1 by the predetermined value ΔV.

As above, according to the deceleration assistance apparatus 10, when there is a high possibility that the deceleration of the own vehicle 100 by the deceleration control is not needed because a state in which the decrease of the deceleration speed Gd of the own vehicle 100 is detected at a time point at which the own vehicle 100 enters the curved road Rcurve and the deceleration speed Gd at the time point is equal to or more than the predetermined deceleration speed Gd_th is obtained and the driver is judging that the own vehicle speed V has sufficiently decreased, the target vehicle speed Vtgt is caused to be greater by the predetermined value ΔV or the deceleration control is not executed even when the own vehicle speed V is greater than the target vehicle speed Vtgt. Therefore, it becomes possible to reduce cases in which the driver feels uncomfortable due to the deceleration control being executed when the own vehicle 100 is traveling on the curved road Rcurve.

The present disclosure is not limited to the embodiment described above, and various modified examples can be employed within the scope of the present disclosure.

For example, the target vehicle speed changing condition C1 may be a condition in which the deceleration of the deceleration speed Gd is detected when the own vehicle 100 is traveling on the curved road Rcurve after the own vehicle 100 enters the curved road Rcurve and the deceleration speed Gd at the time point is equal to or more than the predetermined deceleration speed Gd_th.

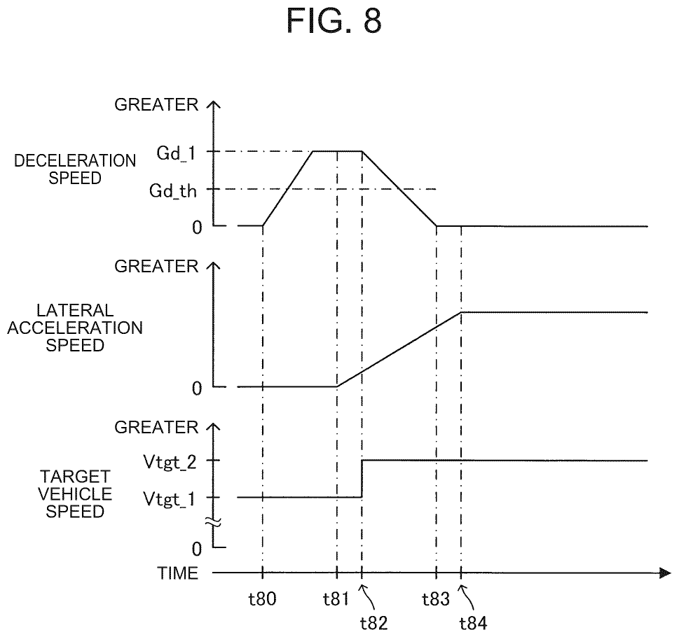

In this case, the target vehicle speed Vtgt is caused to be greater than the predetermined value ΔV as shown in FIG. 8. In other words, in the example shown in FIG. 8, after the deceleration speed Gd starts to rise at time t80, the certain value Gd_1 that is greater than the predetermined deceleration speed Gd_th is reached. Then, the own vehicle 100 enters the curved road Rcurve, and the lateral acceleration speed Gy starts to rise at time t81. Then, the deceleration speed Gd that is equal to or more than the predetermined deceleration speed Gd_th starts to decrease at time t82. Then, the deceleration speed Gd becomes zero at time t83. The lateral acceleration speed Gy continues to rise from time t81 to time t84 and becomes constant at time t84 and thereafter.

In this case, after the own vehicle 100 enters the curved road Rcurve at time t81, the decrease of the deceleration speed Gd is detected at time t82 while the own vehicle 100 is traveling on the curved road Rcurve and the deceleration speed Gd at the time point is equal to or more than the predetermined deceleration speed Gd_th. Therefore, the target vehicle speed changing condition C1 is met at the time point, and hence the target vehicle speed Vtgt is changed to a value Vtgt_2 that is greater than the value Vtgt_1 by the predetermined value ΔV.

Therefore, in the present disclosure, the target vehicle speed changing condition C1 only needs to be a condition in which the decrease of the deceleration speed Gd is detected when the own vehicle 100 is traveling on the curved road Rcurve and the deceleration speed Gd at the time point is equal to or more than the predetermined deceleration speed Gd_th.

In the present disclosure, the target vehicle speed changing condition C1 only needs to be a condition in which at least the decrease of the deceleration speed Gd is detected when the own vehicle 100 is traveling on the curved road Rcurve.

The present disclosure can also be applied to a vehicle that can travel by manual driving operation and autonomous driving control and a vehicle that travels only by manual driving operation. When the present disclosure is applied to those vehicles, the present disclosure is used when the vehicle travels by the manual driving operation. The manual driving operation is driving operation that the operator performs by him/herself to cause the vehicle to travel. The autonomous driving control is control in which the operator does not perform the driving operation for causing the vehicle to travel by him/herself and a control apparatus such as an ECU autonomously causes the vehicle to travel.

What is claimed is:

1. A deceleration assistance apparatus, comprising a control apparatus that executes deceleration control that decelerates a vehicle when a vehicle speed of the vehicle is greater than a target vehicle speed set as a target value of the vehicle speed of the vehicle when the vehicle travels on a curved road, wherein the control apparatus is configured to cause the target vehicle speed to be greater by a predetermined value or is configured to not execute the deceleration control even when the vehicle speed of the vehicle is greater than the target vehicle speed when a predetermined condition in which a decrease of a deceleration speed of the vehicle is detected when the vehicle travels on the curved road is met.

2. The deceleration assistance apparatus according to claim 1, wherein the predetermined condition includes a condition in which the deceleration speed at a time point at which the decrease of the deceleration speed of the vehicle is detected is equal to or more than a predetermined deceleration speed.

3. The deceleration assistance apparatus according to claim 1, wherein the predetermined condition includes a condition in which the decrease of the deceleration speed of the vehicle is detected at a time point at which the vehicle enters the curved road.

4. A deceleration assistance method that executes deceleration control that decelerates a vehicle when a vehicle speed of the vehicle is greater than a target vehicle speed set as a target value of the vehicle speed of the vehicle when the vehicle travels on a curved road, the deceleration assistance method comprising a step of causing the target vehicle speed to be greater by a predetermined value or not executing the deceleration control even when the vehicle speed of the vehicle is greater than the target vehicle speed when a predetermined condition in which a decrease of a deceleration speed of the vehicle is detected when the vehicle travels on the curved road is met.

5. A non-transitory storage medium storing instructions that are executable by one or more processors and that cause the one or more processors to perform functions comprising:
executing deceleration control that decelerates a vehicle when a vehicle speed of the vehicle is greater than a target vehicle speed set as a target value of the vehicle speed of the vehicle when the vehicle travels on a curved road; and
causing the target vehicle speed to be greater by a predetermined value or not executing the deceleration control even when the vehicle speed of the vehicle is greater than the target vehicle speed when a predetermined condition in which a decrease of a deceleration speed of the vehicle is detected when the vehicle travels on the curved road is met.
